(19) United States
(12) Patent Application Publication
(10) Pub. No.: US 2006/0146736 A1
(43) Pub. Date: Jul. 6, 2006

(54) System and method for offering personalized office work

(75) Inventor: Jae-sung Ro, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/326,402

(22) Filed: Jan. 6, 2006

(30) Foreign Application Priority Data
Jan. 6, 2005 (KR) 10-2005-0001263

(51) Int. Cl. H04L 12/16

(52) U.S. Cl. 370/260

(57) ABSTRACT

A system and method for offering personalized office work which draws patterns of office work that are different for respective users through the analysis of user's way of using services and particulars of terminal change, and which provides services that meet the respective office work patterns. An apparatus for offering personalized office work includes a storage unit for storing personal information, an input unit for receiving an input of a service request, and an office agent for transmitting the personal information and the input service request and receiving services for users and that are extracted with reference to the personal information and information on a terminal that has transmitted the personal information.

### CROSS-REFERENCE TO RELATED APPLICATION

This application claims priority from Korean Patent Application No. 10-2005-0001263 filed on Jan. 6, 2005 in the Korean Intellectual Property Office, the disclosure of which is incorporated herein by reference in its entirety.

### BACKGROUND OF THE INVENTION

1. Field of the Invention

Systems and methods consistent with the present invention relate to offering personalized office work, and more particularly to offering personalized office work which draws patterns of office work that are different by persons through the analysis of user's way to use services and particulars of terminal change and provides services that meet the office work patterns.

2. Description of the Prior Art

With the development of information technology, many enterprises have introduced a great number of solutions in order to increase information efficiency, and recent trends show a tendency toward integration. Respective enterprises have established groupware and intranets in order to share in-house information, and to enable users to do office work which is centrally managed by making the users access a server constructed in the enterprise by using a client.

Additionally, respective enterprises have established systems for enterprise resource planning, customer relations management, supply chain management, etc. Also, as the Internet has developed, respective enterprises have established home pages and (Business-to-Consumer) B2C or (Business-to-Business) B2B systems for electronic commerce.

However, since it is still difficult to find necessary information even in such a flood of information systems, an enterprise portal for an efficient process of office work is rapidly spreading which can increase the convenience and the productivity of office work by integrating various kinds of information involved inside/outside the enterprise such as intranet, groupware, enterprise resource planning, customer relations management, supply chain management, electronic document management system, knowledge management system, etc., through a single interface and by providing the information to meet the user's requirement.

An enterprise portal is an application that integrates information inside/outside the enterprise and enables users, who intend to use the information, to make important decisions through a single gateway. Enterprise portals offer personal access to enterprise information within a specified range.

FIG. 1 is a view illustrating a conventional integrated enterprise management system by fixed terminals.

A user in an enterprise can access an in-house network 14 that provides services such as an enterprise portal, work file storage server, back office system, etc., using a terminal 10 which is provided to the user. In this case, groupware 12 serves as an interface that connects the user's terminal 10 to the in-house network 14, and through this groupware, services such as a mail, sanction, morning meeting of officers and staffs, etc., can be provided to the user.

By way of illustration, the groupware 12 refers to the software or structure that includes the software for offering group work among persons apart from one another, which is in contrast to personal software.

Specifically, the term “groupware” means software which members of an enterprise, institution or organization use in cooperation with one another in workplaces that are connected together by computers in order to increase work efficiency. Such software is designed to be suitable for persons of a small-scaled group to do the same work or joint work on schedule. With the development of computer networks, groupware has also been developed which can generally be used by the group from the beginning and which can efficiently operate on a network by changing the existing application programs to a LAN (local area network) standard.

FIG. 2 is a view illustrating a conventional integrated enterprise management system with mobile communication terminals.

A server-client system has been proposed as a means for enabling a person in an enterprise to continue his/her office work without inconvenience, even if he/she changes terminals due to his/her movement, etc. while working.

Additionally, a method that extends the concept of the server-client system mentioned above has been proposed. According to this method, a user can access the in-house network 26 from outside of the enterprise using a portable terminal 20 such as a portable phone, PDA, etc. Thus, the user can do office work such as management of a notice board, E-mail, schedule management, management of an address book, management of results, etc., and can receive a position information service by accessing groupware 24 in the enterprise through a wireless communication station 22 using a portable terminal 20.

Korean Unexamined Patent Publication No. 10-2003-0001724 discloses a mobile office system which can achieve a smooth understanding among the members of a group and can improve the efficiency of office work by expanding the wired work environment of the enterprise into a wire/wireless integrated environment. Respective users of an enterprise have their own work systems and patterns according to their position, post, given task work, personal taste, etc. However, the enterprise portal or server-client system is merely a system for integratedly managing the office work, and thus it is difficult to provide the users with services that take into account the different work systems and patterns of respective users.

### SUMMARY OF THE INVENTION

Accordingly, exemplary embodiments of the present invention solve the above-mentioned disadvantages occurring in the prior art and other disadvantages not described above. Also, the present invention is not required to overcome the disadvantages described above, and an exemplary embodiment of the present invention may not overcome any of the problems described above. Further, it is an aspect of the present invention to draw patterns of office work that are different by respective users through an analysis of a user's way of using services and the particulars of terminal changes and to provide services that meet the respective office work pattern.

According to an aspect of the present invention, there is provided an apparatus for offering personalized office work, according to an exemplary embodiment of the present invention, which comprises a storage unit for storing personal information, an input unit for receiving an input of a service request, and an office agent for transmitting the personal information and the input service request and for receiving services for by persons which are extracted with reference to the personal information and information on a terminal that has transmitted the personal information.

In another aspect of the present invention, there is provided an apparatus for offering personalized office work, which comprises a receiving unit for receiving personal information or a service request, an extracting unit for extracting services for persons with respect to the requested service using information on whether to provide the service and a service providing method determined by the received personal information and pre-stored terminal information, and a transmitting unit for transmitting the extracted service.

In still another aspect of the present invention, there is provided a method for offering personalized office work, which comprises the operations of receiving an input of a service request, and transmitting the personal information and the input service request and receiving services for persons which are extracted with reference to the personal information and information on a terminal that has transmitted the personal information.

In still another aspect of the present invention, there is provided a method for offering personalized office work, which comprises the operations of receiving personal information or a service request, extracting services for persons with respect to the requested service using information on whether to provide the service and a service providing method determined by the received personal information and pre-stored terminal information, and transmitting the extracted service.

### BRIEF DESCRIPTION OF THE DRAWINGS

The above and/or other aspects of the present invention will become more apparent from the following detailed description of exemplary embodiments thereof, with reference to the accompanying drawings, in which:

FIG. 1 is a view illustrating a conventional integrated enterprise management system using fixed terminals;

FIG. 2 is a view illustrating a conventional integrated enterprise management system using mobile communication terminals;

FIG. 3 is a block diagram illustrating a system for offering personalized office work according to an exemplary embodiment of the present invention;

FIG. 4 is a view illustrating the structure of a server for offering personalized office work according to an exemplary embodiment of the present invention;

FIG. 5 is a block diagram illustrating a terminal for offering personalized office work according to an exemplary embodiment of the present invention;

FIG. 6 is a block diagram illustrating a business-place server for offering personalized office work according to an exemplary embodiment of the present invention;

FIG. 7 is a flowchart illustrating the operation of a terminal for offering personalized office work according to an exemplary embodiment of the present invention; and

FIG. 8 is a flowchart illustrating the operation of a business-place server for offering personalized office work according to an exemplary embodiment of the present invention.

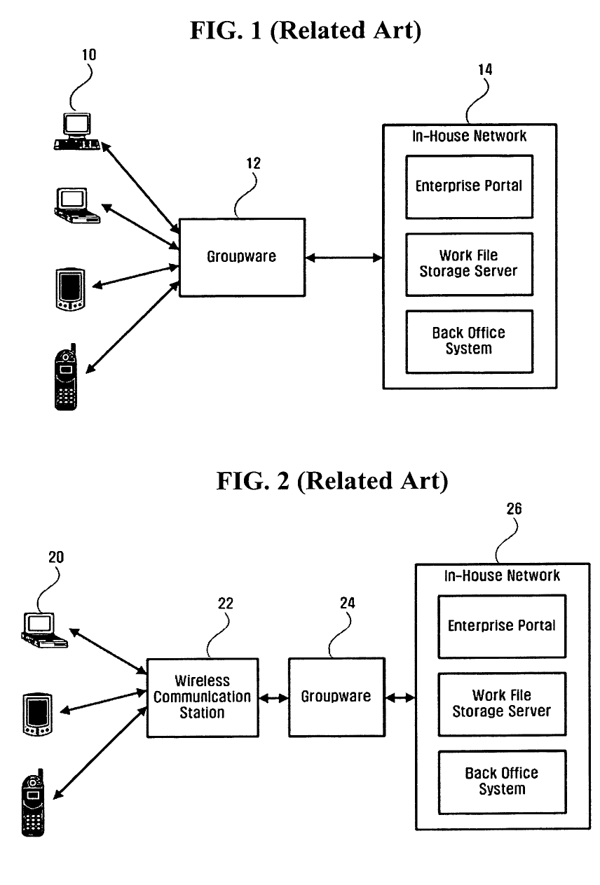

### DETAILED DESCRIPTION OF THE EXEMPLARY EMBODIMENTS OF THE INVENTION

Hereinafter, exemplary embodiments of the present invention will be described in detail with reference to the accompanying drawings. The aspects and features of the present invention and methods for achieving these aspects and features will become apparent by referring to the exemplary embodiments. However, the present invention is not limited to the exemplary embodiments disclosed herein, but will be implemented in diverse forms. The matters defined in the following description, such as detailed construction and elements, are nothing but exemplary details provided to assist those of ordinary skill in the art with a comprehensive understanding of the present invention, and the present invention is only defined by the scope of appended claims. Throughout the following description of the present invention, the same drawing reference numerals are used to denote the same elements among/across various figures.

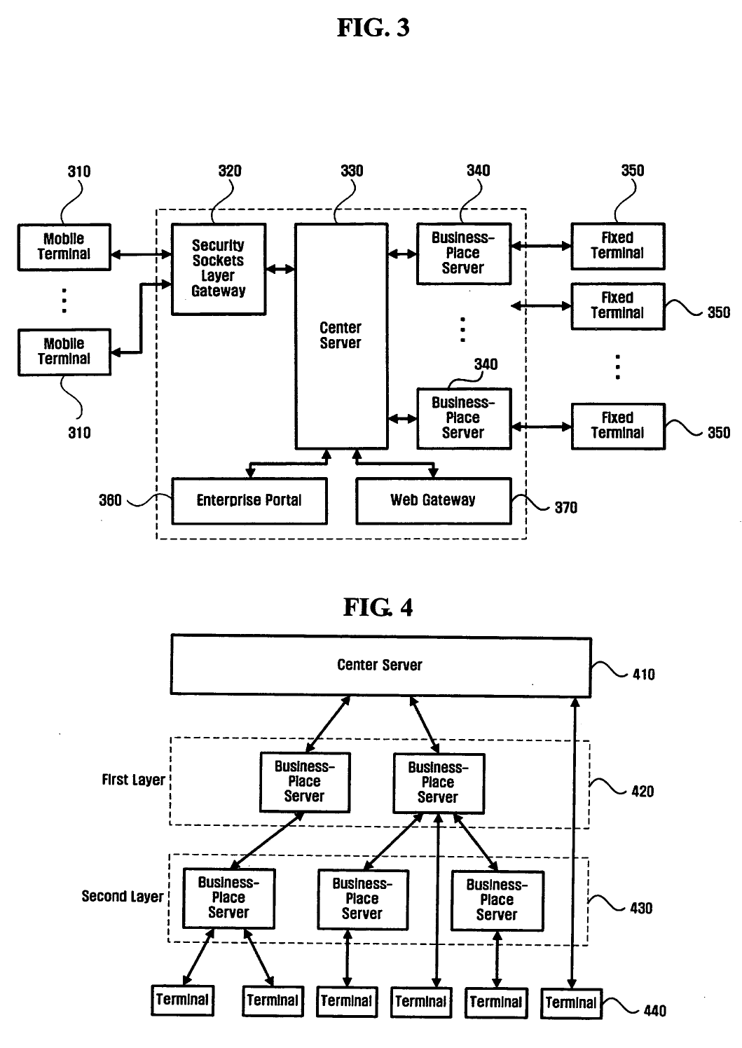

FIG. 3 is a block diagram illustrating a system for offering personalized office work according to an exemplary embodiment of the present invention.

The system for offering personalized office work according to the exemplary embodiment shown in FIG. 3 includes fixed terminals 350, mobile terminals 310, a secure sockets layer gateway (or groupware) 320, a center server 330, business-place servers 340, an enterprise portal unit 360 and a web gateway 370.

The fixed terminals 350 are terminals that are connected to a wire/wireless network provided inside the enterprise, and include desktops, laptops, tablet personal computers (PCs), personal digital assistants (PDAs), portable phones, etc. Preferably, but not necessarily, the fixed terminals 350 correspond to desktops or laptops which are connected to a wire network.

The fixed terminals 350 are provided with an office agent which is an application program and the fixed terminals 350 actually communicate with the business-place server 340 through the office agent.

The mobile terminals 310 are terminals that are connected to a wire/wireless network provided outside the enterprise, and include desktops, laptops, tablet PCs, PDAs, portable phones, etc. Preferably, but not necessarily, the mobile terminals 310 correspond to laptops, tablet PCs, PDAs or portable phones which are connected to a wireless network.

The mobile terminals 310 are also provided with an office agent that is an application program, and the mobile terminals 310 communicate with the center server 330 through the office agent. In this case, the secure sockets layer gateway 320 relays data securely between the mobile terminals 310 and the center server 330.

The secure sockets layer gateway 320 is a gateway that is installed in the enterprise for secure communications between the mobile terminals 310 and the center server 330 Through the secure sockets layer gateway 320, the mobile terminals 310 and the center server 330 perform encrypted communications with each other using a public key and a private key.

The business-place server 340 is a server that is positioned in the enterprise according to the field of office work or spatial circumstances for managing terminals that belong to the corresponding business place. One or two or more business-place servers may exist in the enterprise.

The business-place server 340 serves to store the work contents of the fixed terminals 350 by communicating with the fixed terminals 350 in the business place using provided communication lines, or serves to store the work contents of the mobile terminals 310 through the center server 330. Also, the business-place server 340 serves to store and analyze the personal information and the terminal information of a user who has logged in and serves to provide a personalized service that meets the analyzed information.

The personalized service is a service that is provided in consideration of not only the user's position, post, given task work, personal taste, etc., but also in consideration of the performance of the presently used terminal, the user's security grade, etc., and services according to the user conditions and the terminal conditions are provided to the respective users.

For example, a user may be allocated with one of a plurality of security grades and, accordingly, the authority to access a service in a business place or the authority to access a service in another business place may be discriminated. Also, by allocating one of a plurality of security grades to a user, the authority to access a service using the fixed terminals 350 in the assigned business place and the authority to access a service using the fixed terminals 350 or the mobile terminals 310 in another business place may be discriminated.

Additionally, the discriminated services may be provided in accordance with the performance of the terminal. For example, in the case of document work, only a search function is provided to the mobile terminals 310, since the editing of a document can be performed using the fixed terminals 350, but cannot be performed using the mobile terminals 310. Further, in the case of transmitting a text message using the mobile terminals 310, a short-cut key or voice information is converted into text to be transferred to an opposite party. Moreover, in the case of video conference using the mobile terminals 310, the figure/voice of an opposite party is not displayed/outputted through a display screen/speaker, but only the text is displayed on the display screen.

The performance of the terminal includes existence/nonexistence of input/output devices such as a keyboard, microphone, touch pen, camera, speech recognition sensor, etc., maximum resolution of a display unit and data transmission/reception rate.

Accordingly, it is preferable, but not necessary, that the personal information includes the user's position, post, schedule, particulars of service search, video conference data, particulars of message transmission, office work files that have been recently processed, state of work proceedings, primarily used service, sharing of a file, particulars of transfer or reception of a notification, etc.

It is also preferable, but not necessary, that the terminal information includes a terminal access time, terminal access end time, terminal change time, period of change, primarily used terminal, terminal performance, etc. The terminal change may be a change between fixed terminals 350 in a business place, a change between mobile terminals 310 outside the enterprise, or change between a fixed terminal 350 and a mobile terminal 310.

In the case in which the terminal is changed, the recently used terminal is logged out, and the service usage and the particulars of the terminal change stored in the terminal are transmitted to, and stored in, the business-place server 340. Then, if the terminal change is completed and the user logs in again, the business-place server 340 extracts the stored personal information and the terminal information using the user login information and provides the personalized service accordingly.

The center server 330 is a server that manages one or more business-place servers 340 through secure communications with one or more business-place servers 340. The business-place servers 340 can transfer the enterprise portal and web gateway services to a terminal by accessing the enterprise portal unit 360 and the web gateway 370, through the center server 330.

Additionally, as described above, the mobile terminals 310 access the center server 330 through the secure sockets layer gateway 320, and the center server 330 also serves to provide a working environment to the user of a mobile terminal 310 in the business place by connecting the mobile terminal 310 to the business-place server 340.

By way of example, the center server 330 and the business-place server 340 may have different constructions according to the scale and structure of the enterprise. As shown in FIG. 4, one or a plurality of first-layer business-place servers 420 may be connected to one center server 410, and one or a plurality of second-layer business-place servers 430 may be connected to the first-layer business-place servers 420.

Additionally, terminals 440 can receive services by accessing the center server 410 or the first-layer business-place servers 420 and the second-layer business-place servers 430. In this case, the server that provides the personalized service according to the personal information and the terminal information may be the presently connected business-place server, upper-layer server, or center server 410.

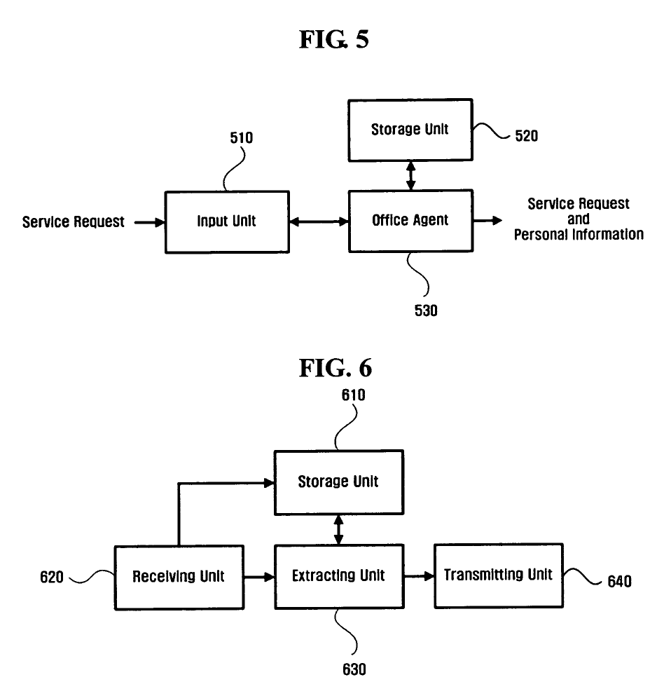

FIG. 5 is a block diagram illustrating a terminal for offering personalized office work according to an exemplary embodiment of the present invention.

The terminal for offering personalized office work may be a fixed terminal 350 or a mobile terminal 310, which includes a storage unit 520, an input unit 510 and an office agent 530.

The storage unit 520 serves to store personal information such as the user's position, post, schedule, particulars of service search, video conference data, particulars of message transmission, office work files that have been recently processed, state of work proceedings, primarily used service, sharing of a file, particulars of transfer or reception of a notification, etc.

The user can access the center server 330 or the business-place servers 340 by changing the terminal. Accordingly, plural users may do their office work using one terminal, and thus it is preferable, but not necessary, that the storage unit 520 stores the personal information of the users.

The input unit 510 serves to receive an input of a service request from the user. The user inputs the service request using an input device such as a keyboard, button, touchpad, track ball, speech recognition device, etc., and the input unit 510 transfers the input service request to the office agent 530.

The office agent 530 is an application program, installed in the terminal, for providing personalized service to the user of the terminal. The office agent 530 serves to transmit a service request transferred from the input unit 510 to the business-place server 340 and provides the service to the user in response to the service request.

When the user logs in, the office agent 530 transmits not only the identity of the user who is presently using the terminal but also transmits the user's personal information and the terminal information stored in the storage unit 520 to the business-place servers 340, and thus the business-place servers 340 can provide the services requested by users, to the users.

Here, the services requested by users may include, for example, a service search, video conference, message transmission, sharing of information, etc.

The service search is a function of offering the terminal user rapid access to a corresponding service, and the user can access a desired service through a simple manipulation such as ‘one-click’ and so on with respect to services inside/outside the enterprise using the enterprise portal 360 and the web gateway 370, which are connected to the center server 330.

The video conference is a service for providing a video conference to the user of a terminal connected to a business-place server 340. The message transmission is a service providing the transmission of a message using an interface that corresponds to the particular kind of terminal being used.

The notification of information is a service for notifying the user of the enterprise, post, specified office work, dining arrangements, schedule pre-stored by the user, etc., and includes a notification message by a notification window and so on or a notification sound.

The office agent 530 which is installed in the mobile terminal 310 communicates with the center server 330 through the secure sockets layer gateway 320. Since the center server 330 serves to relay data between the office agent 530 and the business-place server 340, the user of the mobile terminal 310 can receive the same work environment as the user of the fixed terminal 350.

FIG. 6 is a block diagram illustrating the business-place server 340 for offering personalized office work according to an exemplary embodiment of the present invention.

The business-place server 340 includes a receiving unit 620, a storage unit 610, an extracting unit 630 and a transmitting unit 640.

The receiving unit 620 serves to receive the user's personal information and the terminal information. The received personal information and the terminal information are transferred to and stored in the storage unit 610 so that they match the login information.

Additionally, the receiving unit 620 receives the service request from a mobile terminal 310 or a fixed terminal 350 and transfers the received service request to the extracting unit 630.

The extracting unit 630 that has received the service request extracts the services requested by the user using the user's personal information and the terminal information stored in the storage unit 610 with reference to the login information.

Specifically, the extracting unit 630 determines whether to provide the service, a service providing method, etc., with reference to the user's personal information such as the user's position, post, schedule, service search, video conference, message transmission, office work file that has been recently processed, state of work proceedings, sharing of a file, transfer or reception of a notification, etc., and the terminal information such as the terminal access time, terminal access end time, terminal change time, period of change, primarily used terminal, terminal performance, etc.

The extracting unit 630 determines whether to provide the requested service according to the personal information. That is, the authority to access the service is judged according to the user's security grade which is given by the personal information.

Also, the service providing method is determined according to the terminal information, and includes, for instance, the conversion of video and voice information into text, transfer of the text to another party, transfer of the text and voice information according to a short-cut key to another party, etc., in consideration of the performance of the terminal such as a keyboard, microphone, touch pen, camera and speech recognition sensor, the maximum resolution of the display unit and the data transmission/reception rate.

Here, since plural users may do their office work using one terminal, it is preferable, but not necessary, that the storage unit 610 stores the personal information and the terminal information of the users.

The service extracted by the extracting unit 630 is transmitted to a mobile terminal 310 or to a fixed terminal 350 through the transmitting unit 650.

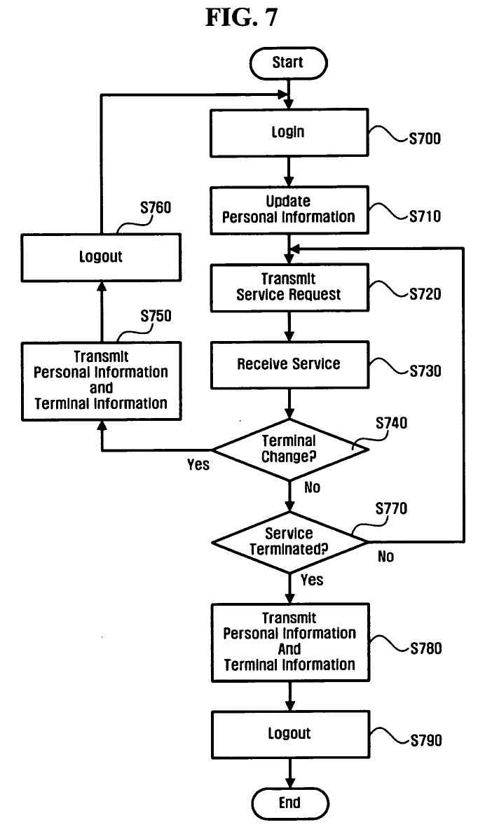

FIG. 7 is a flowchart illustrating the operation of a terminal, such as a fixed terminal 350 or a mobile terminal 310, for offering personalized office work according to an exemplary embodiment of the present invention.

The fixed terminal 350 or the mobile terminal 310 accesses the business-place server 340 using the user's login information (operation S700).

The office agent 530, which is installed in the mobile terminal 310 or in the fixed terminal 350 can be updated by downloading the newest version of the office agent 530 from the business-place server 340, and in the case of the mobile terminal 310, the office agent 530 can be automatically updated when the mobile terminal 310 is recognized by a specified recognition device which is installed in the business place.

Additionally, in the case of the mobile terminal 310, a separate security authentication process may be added when the mobile terminal 310 accesses the center server 330.

The mobile terminal 310 or the fixed terminal 350 registers new personal information or updates the registered personal information according to a user's command (operation S710). The personal information is stored in the mobile terminal 310 or the fixed terminal 350 and the business-place server 340. When the user first logs in, the mobile terminal 310 or the fixed terminal 350 compares the personal information stored in the business-place server 340 with the personal information stored in the mobile terminal 310 or the fixed terminal 350 itself, and if there is a difference between them, the mobile terminal 310 or the fixed terminal 350 updates the personal information (operation S710).

Accordingly, the mobile terminal 310 or the fixed terminal 350 receives and updates the user's personal information according to the login information from the business-place server 340, so that the user can do the office work in accordance with the recently registered personal information.

Then, the mobile terminal 310 or the fixed terminal 350 receives a service request from the user. The service request is then transmitted to the business-place server 340 (operation S720), and the business-place server 340 transmits the corresponding personalized service to the terminal using the user's personal information and the terminal information.

Then, the mobile terminal 310 or the fixed terminal 350 receives the personalized service from the business-place server 340 (operation S730) and provides the personalized service to the user.

In this case, if the user intends to change the terminal to do the office work (operation S740), the personal information and the terminal information which are stored in the mobile terminal 310 or the fixed terminal 350 are transferred to the business-place server 340 (operation S750) and the terminal is logged out (operation S760). If another terminal is logged in (operation S700), the process is repeated, starting from the personal information updating operation (operation S710).

Further, if the user intends to terminate the service (operation S770), the personal information and the terminal information which are stored in the mobile terminal 310 or the fixed terminal 350 are also transferred to the business-place server 340 (operation S780) and the terminal is logged out (operation S790). If the terminal is logged in after the service is reopened (operation S700), the process is repeated, starting from the personal information updating operation (operation S710).

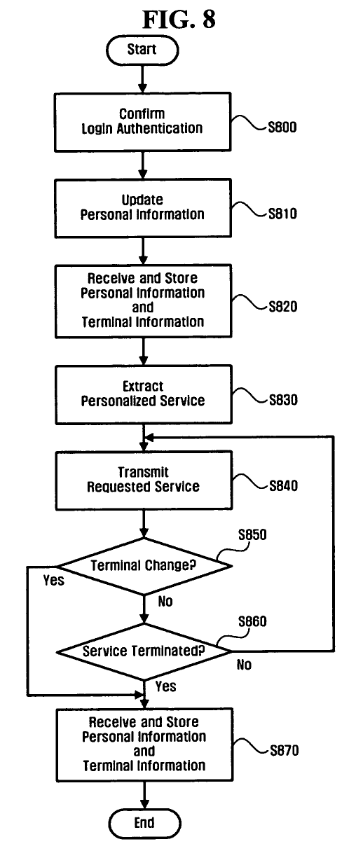

FIG. 8 is a flowchart illustrating the operation of a business-place server for offering personalized office work according to an exemplary embodiment of the present invention.

The business-place server 340, which has received the login information according to the login request from the fixed terminal 350 that has directly accessed the business-place server 340, or from the mobile terminal 310 that has accessed the business-place server 340 through the center server 330, confirms the login authentication (operation S800), and determines whether to access the terminal according to the result of confirmation.

If the login authentication is completed, the business-place server 340 transmits the pre-stored personal information to the mobile terminal 310 or the fixed terminal 350 according to the request of the mobile terminal 310 or the fixed terminal 350 that intends to confirm whether to update the personal information. In the case of a new user, the transmission and update of the personal information may be omitted (operation S810).

Additionally, the business-place server 340 may receive and store the personal information and the terminal information (operation S820) in the case in which the personal information has been corrected by the user or the logged in terminal is not a recently used terminal.

The received personal information and the terminal information are stored in the storage unit 610 to match the user's login information.

The receiving unit 620 receives the service request from the terminal mobile 310 or the fixed terminal 350 and transfers the received service request to the extracting unit 630.

The extracting unit 630, which has received the service request, extracts the services requested by users using the user's personal information and the terminal information stored in the storage unit 610 with reference to the login information (operation S830).

In other words, the extracting unit 630 determines whether to provide a service, a service providing method, etc., with reference to the user's personal information, such as the user's position, post, schedule, service search, video conference, message transmission, office work file that has been recently processed, state of work proceedings, sharing of a file, transfer or reception of a notification, etc., and the terminal information, such as the terminal access time, terminal access end time, terminal change time, period of change, primarily used terminal, terminal performance, etc.

In this case, whether to provide the service is determined according to the personal information. That is, the authority to access the service is judged according to the user's security grade given by the personal information.

Also, the service providing method is determined according to the terminal information, and includes the conversion of video and voice information into a text, transfer of the text to an opposite party, transfer of the text and voice information according to a short-cut key to an opposite party, etc., in consideration of the performance of the terminal such as a keyboard, microphone, touch pen, camera and speech recognition sensor, the maximum resolution of the display unit and the data transmission/reception rate.

The service extracted by the extracting unit 630 is transmitted to the mobile terminal 310 or the fixed terminal 350 through the transmitting unit 640 (operation S840).

Moreover, if the terminal is changed by the user (operation S850) or if the service is terminated (operation S860), the business-place server 340 receives and stores the personal information and the terminal information from the mobile terminal 310 or the fixed terminal 350 (operation S870). After this, if the mobile terminal 310 or the fixed terminal 350 accesses the business-place server 340 with the same login information, the business-place server 340 provides the service using the stored personal information and the terminal information.

As described above, the system and the method for offering personalized office work according to exemplary embodiments of the present invention have the following effects and other effects.

First, by extracting information regarding whether to provide a service and a service providing method through the analysis of a user's personal information, terminal information, etc., and by providing the service accordingly, the convenience and efficiency of office work proceedings can be increased.

Second, the management or the manager of the enterprise can easily grasp the office work pattern and the state of the officers and staff.

Although exemplary embodiments of the present invention have been described above for illustrative purposes, those skilled in the art will appreciate that various modifications, additions and substitutions are possible with respect to the exemplary embodiments, without departing from the scope and spirit of the invention as defined in the accompanying claims.

What is claimed is:

1. An apparatus for offering personalized office work, the apparatus comprising:
a storage unit which stores personal information;
a terminal which transmits the personal information;
an input unit which receives an input comprising a service request; and
an office agent which transmits the personal information and the input service request and receives at least one service for a user,
wherein the at least one service is extracted with reference to the personal information and with reference to terminal information about the terminal.

2. The apparatus as claimed in claim 1, wherein the personal information comprises at least one of a position of a user, a post, a schedule, particulars of a service search, video conference data, particulars of message transmission, an office work file that has been recently processed, state of work proceedings, a primarily used service, file-sharing information, particulars of notification transmission and particulars of notification reception.

3. The apparatus as claimed in claim 1, wherein the terminal information comprises at least one of a server access time, a server access end time, a terminal change time, a period of terminal change, a primarily used terminal and information regarding terminal performance.

4. The apparatus as claimed in claim 1, wherein the at least one service for a user comprises a service that is extracted in accordance with information indicating whether to provide the at least one service,
wherein the information indicating whether to provide the at least one service is determined according to a grade of the user by a service providing method, which is determined by the terminal information, and
wherein the grade of the user is determined by the personal information.

5. The apparatus as claimed in claim 4, wherein the at least one service for a user comprises at least one of a service search, a video conference, a message transmission, file-sharing and information notification.

6. An apparatus for offering personalized office work, the apparatus comprising:
a receiving unit which receives at least one of personal information and a service request;
an extracting unit which extracts at least one service for a user, wherein the extracting unit uses information indicating whether to provide the at least one service, and wherein the extracting unit also uses a service providing method which is determined by the received personal information and pre-stored terminal information; and
a transmitting unit which transmits the at least one extracted service.

7. The apparatus as claimed in claim 6, wherein the personal information comprises at least one of a position of a user, a post, a schedule, particulars of a service search, video conference data, particulars of message transmission, an office work file that has been recently processed, state of work proceedings, a primarily used service, file-sharing information, particulars of notification transmission and particulars of notification reception.

8. The apparatus as claimed in claim 7, wherein the personal information is stored and updated in a server during a logout of a first terminal, and is then transmitted to a second terminal that is accessed using login information that is substantially identical to login information that was used to access the first terminal.

9. The apparatus as claimed in claim 6, wherein the terminal information comprises at least one of a server access time, a server access end time, a terminal change time, a period of terminal change, a primarily used terminal and information regarding terminal performance.

10. The apparatus as claimed in claim 6, wherein the at least one service for a user comprises at least one of a service search, a video conference, a message transmission, file-sharing and information notification.

11. A method for offering personalized office work, the method comprising:
receiving an input comprising a service request; and
transmitting personal information and the input service request; and
receiving services by a user, wherein the services are extracted with reference to the personal information and information regarding a terminal that has transmitted the personal information.

12. The method as claimed in claim 11, wherein the personal information comprises at least one of a position of a user, a post, a schedule, particulars of a service search, video conference data, particulars of message transmission, an office work file that has been recently processed, state of work proceedings, a primarily used service, file-sharing information, particulars of notification transmission and particulars of notification reception.

13. The method as claimed in claim 11, wherein the terminal information comprises at least one of a server access time, a server access end time, a terminal change time, a period of terminal change, a primarily used terminal and information regarding terminal performance.

14. The method as claimed in claim 11, wherein the at least one service for a user comprises a service that is extracted in accordance with information indicating whether to provide the at least one service,
wherein the information indicating whether to provide the at least one service is determined according to a grade of the user by a service providing method, which is determined by the terminal information, and
wherein the grade of the user is determined by the personal information.

15. The method as claimed in claim 14, wherein the services by persons comprise at least one of a service search, video conference, message transmission, file-sharing and information notification.

16. A method for offering personalized office work, the method comprising:
receiving at least one of personal information and a service request;
extracting at least one service for a user by using information indicating whether to provide the at least one service and by using a service providing method which is determined by the received personal information and pre-stored terminal information; and
transmitting the at least one extracted service.

17. The method as claimed in claim 16, wherein the personal information comprises at least one of a position of a user, a post, a schedule, particulars of a service search, video conference data, particulars of message transmission, an office work file that has been recently processed, state of work proceedings, a primarily used service, file-sharing information, particulars of notification transmission and particulars of notification reception.

18. The method as claimed in claim 17, wherein the personal information is stored and updated in a server during a logout of a first terminal, and is then transmitted to a second terminal that is accessed using login information that is substantially identical to login information that was used to access the first terminal.

19. The method as claimed in claim 16, wherein the terminal information comprises at least one of a server access time, a server access end time, a terminal change time, a period of terminal change, a primarily used terminal and terminal performance.

20. The method as claimed in claim 16, wherein the at least one service for a user includes at least one of a service search, a video conference, message transmission, file-sharing and information notification.
